(19) United States
(12) Patent Application Publication
(10) Pub. No.: US 2016/0140457 A1
(43) Pub. Date: May 19, 2016

(54) WORKING MULTIPLE BOOKINGS OFF A QUEUE IN ONE STEP

(71) Applicants: Susan M. Dohm, Apex, NC (US); Karen J. Berg, Eagan, MN (US); Venkatesh M. Pazhyanur, Eagan, MN (US)

(72) Inventors: Susan M. Dohm, Apex, NC (US); Karen J. Berg, Eagan, MN (US); Venkatesh M. Pazhyanur, Eagan, MN (US)

(73) Assignee: Unisys Corporation, Blue Bell, PA (US)

(21) Appl. No.: 14/547,620

(22) Filed: Nov. 19, 2014

(51) Int. Cl. G06Q 10/02

(52) U.S. Cl. CPC G06Q 10/02

(57) ABSTRACT

The present invention provides apparatuses and methods for filtering queued booking and air waybills in a centralized system. Various embodiments of the invention may reserve bookings from multiple sources and generate air waybills associated with the bookings. The bookings and air waybills may be aggregated in a centralized system and filtered according to several attributes. The integration of a centralized system may allow filtered bookings may be worked on by a user of any facility at any time. As a result, workloads may be distributed between several facilities, thus providing an efficient means for managing bookings and air waybills in a timely manner.

### FIELD OF THE DISCLOSURE

The instant disclosure relates to system management. More specifically, this disclosure relates to the working multiple queued bookings in a central application.

### BACKGROUND

Air waybills are essential to any process related to the shipment of goods anywhere in the world. They may serve as a receipt of goods by an airline and may represent a contract between a shipper of goods and the airline responsible for transporting the goods to the desired location. Air waybills may include terms and conditions of carriage such as the air carrier's limits of liability, a description of goods, and applicable charges.

Booking reservations may be placed by a shipper that require approval from several flight control locations. A shipper of furniture cargo may book a reservation at a local call center that requires approval from a flight controller at location A, while a shipper of surfing equipment may book a reservation using the airline's portal on the local computer system that requires approval from a flight controller at location B. Because the local computer portal manages only the bookings that are made at that site, the shipper of surfing equipment may only be allowed to check the status of his shipment and must wait for any necessary approvals from the flight control center's local computer system. This task may be complicated by barriers such as the flight control center may be closed for business at a time when the surfer equipment shipper wants updated information related to his/her shipment. The same problem may exist for the shipper of furniture who desires to check the status of his/her shipment but is not able to access the local call center and must also wait for any necessary approvals from flight control location.

In addition, if several bookings require approval from one flight control location, and that location is understaffed, an undesirable wait time may exist for the shipper. If the shipper is shipping perishable goods or flammable materials, delayed execution of shipment may be critical to consumers of the shipped goods. Moreover, when a particular flight control location is understaffed, it would be more efficient to allow staff members who work at other flight control locations that are less filled with bookings to assist in processing time-sensitive bookings and air waybills; however, a staff member at another flight control location would be burdened with searching a long list of queued bookings to find a correct booking to work on. Thus, a method for managing and filtering bookings so that queued bookings are processed (approved, updated or rejected) based on priority so that a shipper of any goods is able to obtain information related to a queued shipment may be beneficial to both shippers and consumers and provide a more efficiency means for booking shipments and processing air waybills.

FIG. 1 illustrates an example of a computer system processing local bookings according to the conventional approach. Typically, both a call center 100 and a flight control center 120 comprises a computing system that includes processing units 102 and 122, databases 104 and 124, other computing components 106 and 126, and user interfaces 108 and 128. As shown in the figure, system components 102, 104, 106, and 108 are associated to the call center 100, and system components 122, 124, 126, and 128 are associated to the flight control center 120. The call center 100 generates booking requests and the flight control center 120 manages bookings at their particular centers. Booking queue 115 represents the bookings that are processed by flight control and arrive at a central database and viewed in the call center's 100 computer system. Booking queue 115 represents the booking requests generated by call center 100 and arrived in database 124 for the flight control center 120. The databases 104 and 124 store information related to the bookings at centers 100 and 120, respectively.

Bookings P, R, S, T, U, V, W, X, Y, and Z that reside in the central database are requested and generated in the call center 100 and require approval by the flight control center 120. Conventionally, representatives of the respective centers are only equipped to manage or process bookings that arise at their center. In a conventional example, if a shipper makes a booking at the call center 100 at 4 p.m. and the reservation of the booking typically takes 45 minutes to process for the flight control center to provide an updated status of approval or non approval, it would be impossible to ship the goods on that day if the last transport of a carrier occurs at 4:15 p.m. Even if the last transport occurs at 4:15 p.m., the flight control center 120 may not be able to work on the booking by the 4:15 p.m. deadline if the flight control center 120 is overworked and understaffed. Although, the flight control center 120 may view all bookings, the absence of a filtering function can cause center 120 to overlook bookings that are high priority. In addition, it is more time-consuming to search a long list of queued bookings to look for a particular booking to work on.

### SUMMARY

The present invention may reduce any delays related to shipping goods anywhere in the world. When a shipper wants to ship goods to a location, the shipper may contact any company associated with shipping goods to reserve a booking. After that company processes the request, information related to the booking is maintained in a centralized computing system. Therefore, if the booking originated at the local air waybill call center, the same information recorded regarding that booking or air waybill may be viewed at the flight control center's local computer system. Additionally, the flight control center's local computer system may view any bookings or air waybills that are sent to the flight control center's local computer system or another flight control center's computer system. As a result, a shipper may earlier track the updated status of his/her shipment.

A new filtering function may be integrated into the user interface to allow the management of queued bookings and air waybills to be viewed according to attributes that are associated with the bookings and air waybills. Bookings and air waybills may be separated by the filter function for easy viewing and management. Users may set up filters with a number of attributes to allow the workload of queued bookings to be split up in a logical manner. The addition of this centralized management of bookings and air waybills and the filtering function integrated into the user interface may present a fully integrated solution defining how booking requests may be processed efficiently and allow a user to work on multiple queued bookings in a single step.

According to one embodiment, a method may include receiving at least one booking request from a call center, where the at least one booking request comprises one or more attributes related to the at least one booking request from the call center; receiving at least one booking request at a flight control center, where the at least one booking request comprises one or more attributes related to the at least one booking request to the flight control center; filtering the at least one booking request from the call center to the flight control center in response to a selection of at least one of the one or more attributes related to the at least one booking request from the call center and the one or more attributes related to the at least one booking request to the flight control center; and generating an output based on the filtering of the at least one booking request from the call center and the at least one booking request to the flight control center. The method may further comprise aggregating the at least one booking request from the call center and the at least one booking request to the flight control center and storing the aggregated booking requests from the call center to the flight control center into a database.

According to another embodiment, an apparatus may include a processor and a memory coupled to the processor. The processor may be configured to perform the steps of receiving at least one booking request from a call center, where the at least one booking request comprises one or more attributes related to the at least one booking request from the call center; receiving at least one booking request to the flight control center, where the at least one booking request comprises one or more attributes related to the at least one booking request from the flight control center; filtering the at least one booking request from the call center and the at least one booking request from the flight control center in response to a selection of at least one of the one or more attributes related to the at least one booking request from the call center and the one or more attributes related to the at least one booking request to the flight control center; and generating an output based on the filtering of the at least one booking request from the call center and the at least one booking request to the flight control center. The processor may be further configured to perform the steps of aggregating the at least one booking request from the call center and the at least one booking request to the flight control center and storing the aggregated booking requests from the call center and the flight control center into a database.

According to a further embodiment, a computer program product includes a non-transitory medium having code to receive at least one booking request from a call center, where the at least one booking request comprises one or more attributes related to the at least one booking request from the call center; code to receive at least one booking request from a flight control center, where the at least one booking request comprises one or more attributes related to the at least one booking request from the flight control center; code to filter the at least one booking request from the call center and the at least one booking request from the flight control center in response to a selection of at least one of the one or more attributes related to the at least one booking request from the call center and the one or more attributes related to the at least one booking request from the flight control center; and code to generate an output based on the filtering of the at least one booking request from the call center and the at least one booking request from the flight control center. The non-transitory medium of the computer program product further includes code to aggregate the at least one booking request from the call center and the at least one booking request from the flight control center and code to store the aggregated booking requests from the call center and the flight control center into a database.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a limitation of the present invention.

### BRIEF DESCRIPTION OF THE DRAWINGS

For a more complete understanding of the disclosed system and methods, reference is now made to the following descriptions taken in conjunction with the accompanying drawings.

FIG. 1 illustrates an example of a computer system processing local bookings according to the conventional approach.

FIG. 2 illustrates an example of multiple computing systems processing multiple bookings that are queued in a centralized location according to one embodiment.

FIG. 3 is a flow chart illustrating a method of managing bookings in a centralized management system according to one embodiment.

FIG. 4 is an illustration of an interface that a user may invoke to reserve a booking according to one embodiment.

FIG. 5 is an illustration of an interface that a user may invoke to generate an air waybill according to one embodiment.

FIG. 6 is an illustration of an interface that a user may operate to create a filter for a booking or an air waybill according to one embodiment.

FIG. 7 is an illustration of an interface that is displayed when a user creates a queue filter according to one embodiment.

FIG. 8 is an illustration of an interface that is displayed when a user views a summary of active filters according to one embodiment.

FIG. 9A is an illustration of an interface that is displayed when a user requests to view information related to a queue filter according to one embodiment.

FIG. 9B is an illustration of an interface that is displayed when an action is submitted to the system according to one embodiment.

FIG. 10 is an illustration of an interface that is displayed to grant authority to a user according to one embodiment.

FIG. 11 is a table depicting an example of assigning priority for an air waybill according to one embodiment.

FIG. 12 illustrates one embodiment of a system for an information system, including a system for generating an application and invoking a method according to one embodiment.

FIG. 13 illustrates a computer system adapted according to certain embodiments of the server and/or the user interface device.

### DETAILED DESCRIPTION

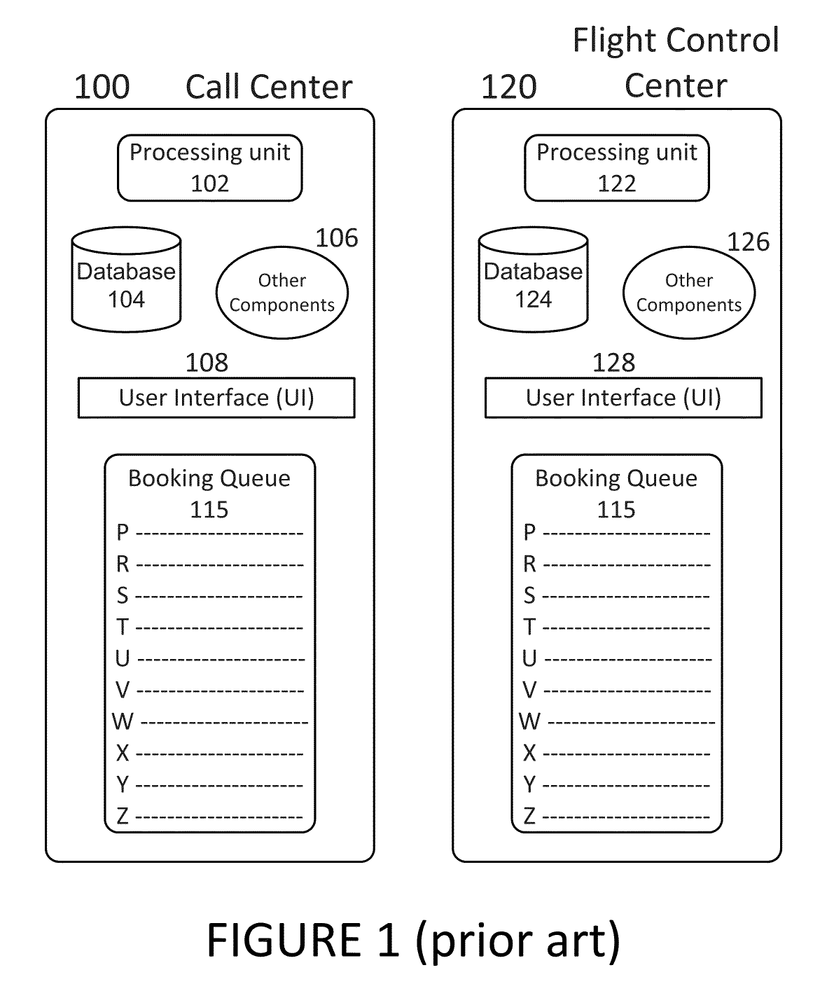

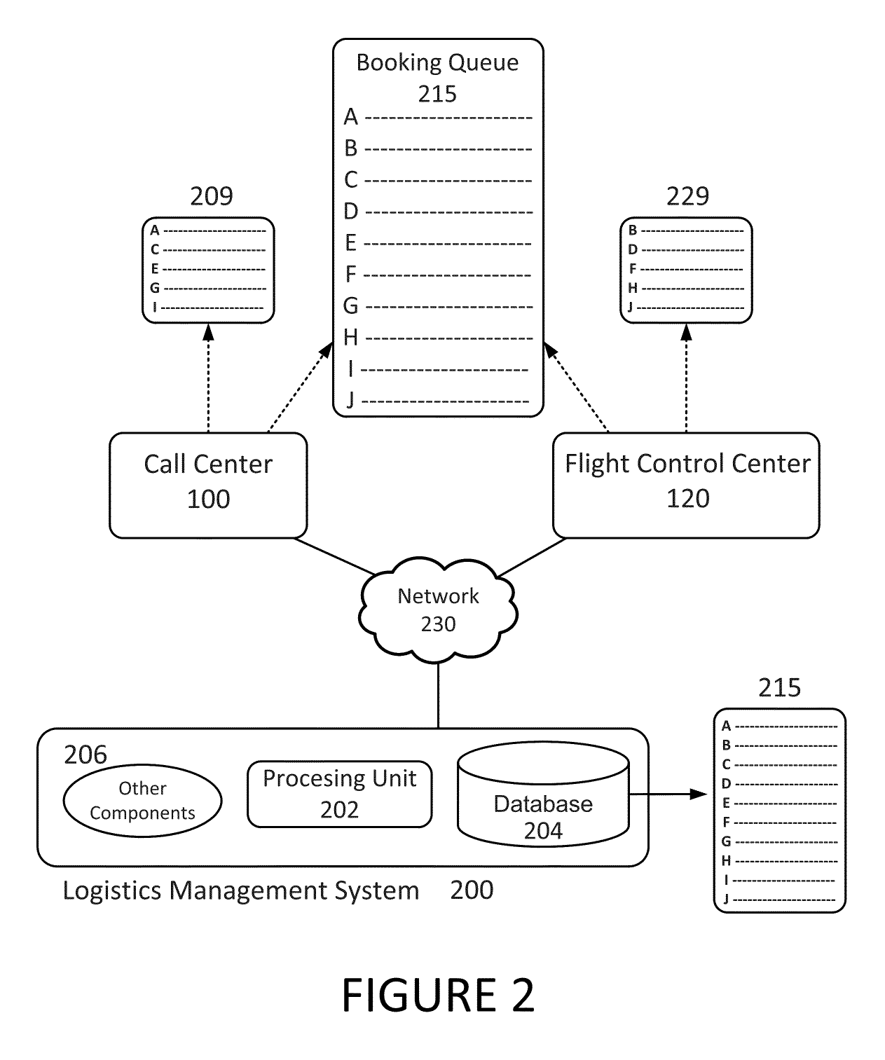

FIG. 2 illustrates an example of multiple computing systems processing multiple bookings that are queued in a centralized location according to one embodiment. A call center 100 and a flight control center 120 may comprise separate computing systems at distinct locations anywhere in the world. Each computing system may include all of the system components discussed in FIG. 1 such as processing units 102 and 122, databases 104 and 124, other computing components 106 and 126, and user interfaces 108 and 128 as well as other system components typically found in a computing system not shown in FIG. 2 such as servers, peripherals, and other components. In a centralized system, bookings and air waybills reserved and generated at one location may be viewed at any location.

When a user at a call center 100 or a flight control center 120 receive a request for a booking or an air waybill denoted as C, the booking may be queued to a common location on a centralized system. In one embodiment, the centralized system may include a Logistics Management System (LMS) 200. LMS 200 may reside at any location and maintain several bookings that are generated at a call center 100, flight control center 120, or any center that handles bookings and air waybills. LMS 200 may include a processing unit 202, a database 204, and other components 206. The processing unit 202 may process all bookings or a subset of bookings and air waybills that are created at a remote location. The processing unit 202 may comprise a server, processor, microprocessor, graphics processing unit (GPU), a field programmable gate array (FPGA), and the like. Database 204 may store the bookings that are collected at the centers 100 and 120 as well as other centers. The storage space on database 204 may be larger than any of the local databases at centers 100, 120, and other centers. The other components 206 may include a random access memory (RAM), a read only memory (ROM), one or more system buses, a keyboard, a pointing device, a touch screen, an input/output (I/O) adapter, a communications adapter, a user interface adapter, a display adapter, and the like.

Bookings and air waybills generated at different centers may be transmitted to the LMS 200 through a network 230. The network may include any type of communications network including, but not limited to, a direct PC-to-PC connection, a local area network (LAN), a wide area network (WAN), a modem-to-modem connection, the Internet, or any other communications network. In addition, the network 230 may include a cloud computing solution developed by Unisys Corporation of any other developer.

In FIG. 2, in one embodiment, the database 204 may comprise all of the bookings A, C, E, G, and I accepted in the call center queue 209 and all of the bookings B, D, F, H, and J accepting in the flight control center queue 229. When aggregated, the database 204 maintains all bookings A, B, C, D, E, F, G, H, I, and J. In addition, the call center 100 and the flight control center 120 may view and manage any booking including those originating from a different center. In addition, one user interface may be invoked by every center that is centralized for management of bookings and air waybills. A new filtering function may be invoked by the LMS 200 to filter the queued bookings that are associated with the call center 100 and those associated with the flight control center 120.

Conventionally, booking queue 215 includes a long list of queued bookings in which a user has to manually aggregate in order to work on selected bookings. With this filtering function, the call center 100 if authorized may not only view the complete list of queued bookings A through J 215 but also view the filtered queued bookings A, C, E, G, and I 209 to work on. Similarly, the flight control center 120 may view the complete list of queued bookings A through J 215 as well as the filtered queued bookings B, D, F, H, and J 229 to work on. Thus, this filtering feature may allow a user to work multiple queued bookings in a single step.

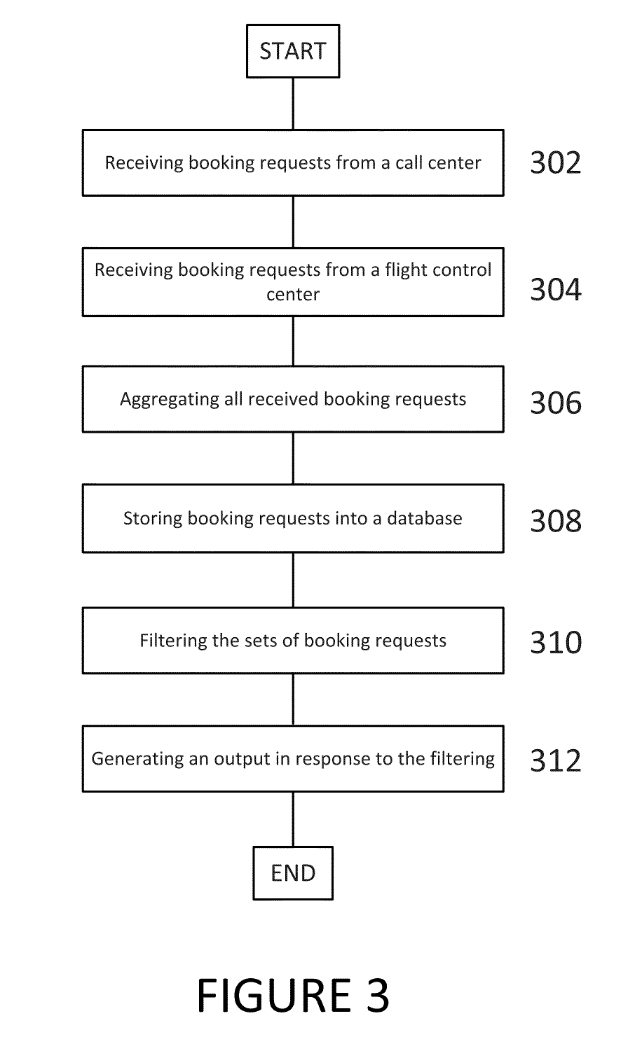

FIG. 3 is a flow chart illustrating a method of managing bookings in a centralized management system according to one embodiment. The method begins at step 302 where a LMS 200 may receive several booking requests from a call center 100. These booking requests may originate from the same shipping client or different shipping clients. Air waybills may be generated based on these booking requests. Furthermore, these booking requests may be made over the phone, through an Internet application, and the like. At step 304, additional booking requests may be received by the LMS 200 from a flight control center 120. Once the LMS receives all of the booking requests from the call center 100 and flight control center 120, the booking requests may be aggregated by the processing unit 202 of the LMS 200 at step 306. After the booking requests and air waybills are aggregated, at step 308, they may be stored into database 204 of LMS 200 to be accessed at any time and worked on by a call center 100 user with authorization or a flight control center 120.

Each booking and air waybill may include a collection of attributes related to the air waybill such as one or more of the name of the shipper, the name of the air carrier, the cost of the shipment, other applicable fees, a queue number indicating when the booking will be worked on, a reason why the booking is queued, a customer segmentation, a date of shipment, and expected date of receipt of goods, an aircraft equipment type and version, the contents of the shipment, an International Air Transport Association (IATA) region, a place of shipment, special handling instructions, and the like. When information pertaining to any of these attributes is requested, the bookings and air waybills may be filtered according to one or more attributes at step 310. If more than one attribute is selected for filtering, the bookings or air waybills may be filtered by a filter priority. For example, a user may desire to work on air waybills shipped from the United States (US) and Canada that need to be processed by some time period in May. If the Canadian air waybills need to be processed by May 15th, a user may give the assign a higher filter priority to the air waybills based on the date of May 15^{th} than based on the country of origin. When the bookings and air waybills are filtered, an output may be generated for logical and simplistic viewing on the call center's user interface 108 or the flight control center's user interface 128. Several methods for outputting the filtered data results may be invoked from the user interface 108 and 128, such as, generating an on-screen filtered list, a spreadsheet, a table, or any graphical representation that may be viewed and worked on by a user.

The following figures illustrate user interfaces that may be invoked by a user to reserve a booking, generate an air waybill, manage queued bookings, certifying an authorized user, and the like. These figures represent single embodiments. It should be appreciated by those skilled in the art that the specific embodiments disclosed may be readily utilized as a basis for modifying or designing other structures for carrying out the same methods, such as disclosed in FIG. 3, of the present invention.

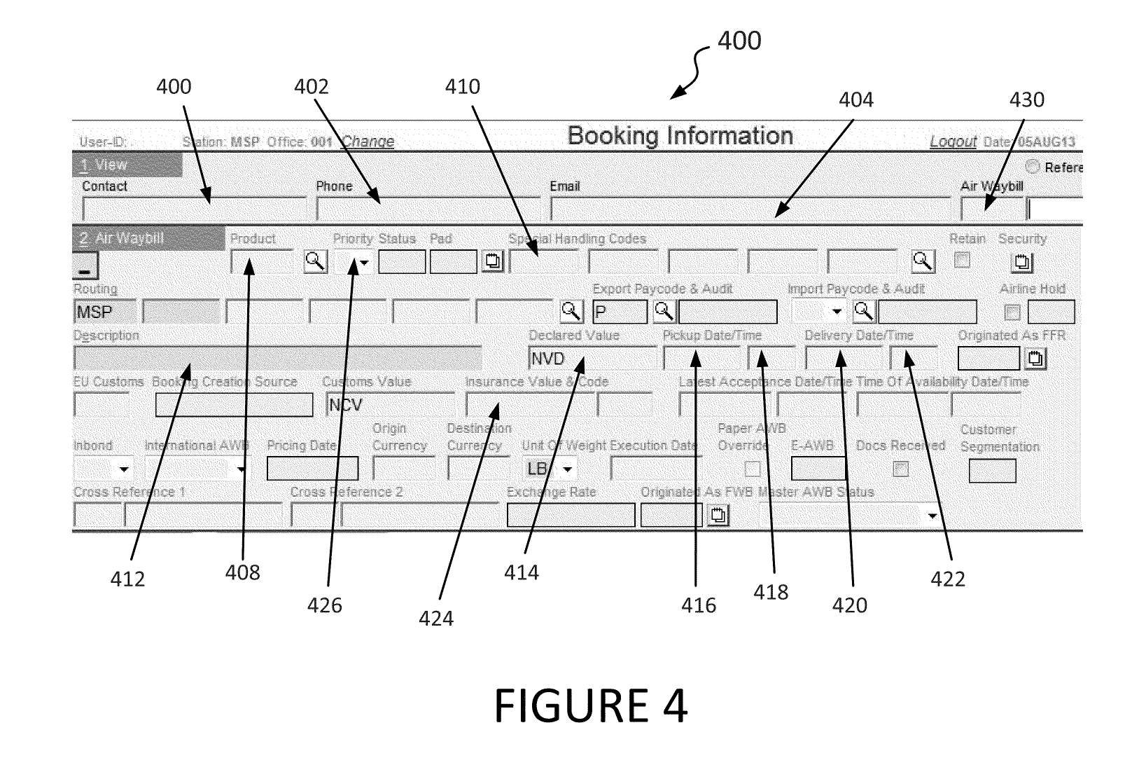

FIG. 4 is an illustration of an interface that a user may operate to reserve a booking according to one embodiment. This interface 400 may be entitled ‘Booking Information’ and include several fields related to a shipper and an air waybill. In the ‘View’ section, a user at a call center 100 or a flight control center 120 may enter a shipper's name 402, phone number 404, email address 406 and other information. An air waybill number 430 may be automatically assigned to a booking or may be entered in manually. In the ‘Air Waybill’ section, the interface 400 may receive and/or display one or more of product code 408, special handling codes 410, a description of the shipment 412, a declared value 414, a pickup date 416, a pickup time 418, a delivery date 420, a delivery time 422, and an insurance value 424.

With the centralized system, a user may possess information about all of the bookings that are in the queue. A booking or air waybill may be worked on based on a priority that exists in the system. Based on a priority of queued bookings, a user may assign a priority to the new booking or air waybill by selecting a value from the drop-down menu 426. A priority of bookings may be generated according to several factors, such as by date and time. In addition, some information in the fields of interface 400 may be manually entered by a user, while others are automatically populated based the interface developer's preference. There are several other fields, drop down menu options, and radio buttons that are present and not present in the figure that may be included in the ‘Booking Information’ interface 400.

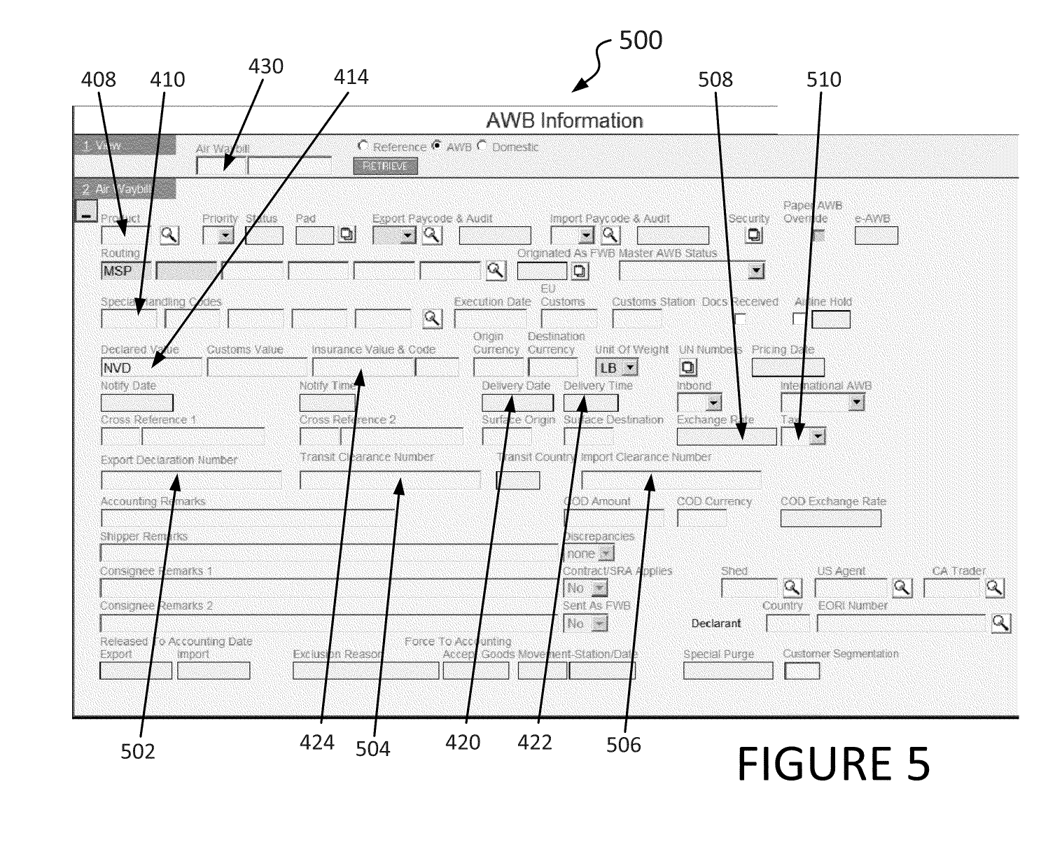

FIG. 5 is an illustration of an interface that a user may operate to generate an air waybill according to one embodiment. This interface 500 may be entitled ‘AWB Information’ and include several fields related to information gathered in reference to a shipper and the generation of an air waybill. In the ‘View’ section, a user may enter an air waybill number 430 to retrieve an air waybill in database 204 to work on or to access information related to a shipper or carrier's inquiry. When an air waybill number 430 is entered into interface 500, a user may click on the ‘RETRIEVE’ button. Upon searching the database 204 after the ‘RETRIEVE’ button is clicked, information that was entered on the ‘Booking Information’ interface 400 may be accessed on interface 500, such as the product code 408, special handling codes 410, a declared value 414, delivery date 420, a delivery time 422, and an insurance value 424. In addition, a collection of other attributes may be viewed on interface 500, such as an export declaration number, 502, a transit declaration number 504, an import clearance number 506, an exchange rate 508, applicable taxes 510 (may be based on percentage), and the like.

The priority that is entered in the booking stage may be maintained or changed based on when a user works on a booking or other external factors. Additionally, the several of the fields and drop-down menus in interface 500 may be modified according to instructions or regulations provided by the shipper, the air carrier, the government or mistakes encountered when the booking was reserved or the air waybill was generated at the call center 100 or the flight control center 120. There may be several other fields, drop down menu options, and radio buttons that are present and not present in the figure that may be included in the ‘AWB Information’ interface 500.

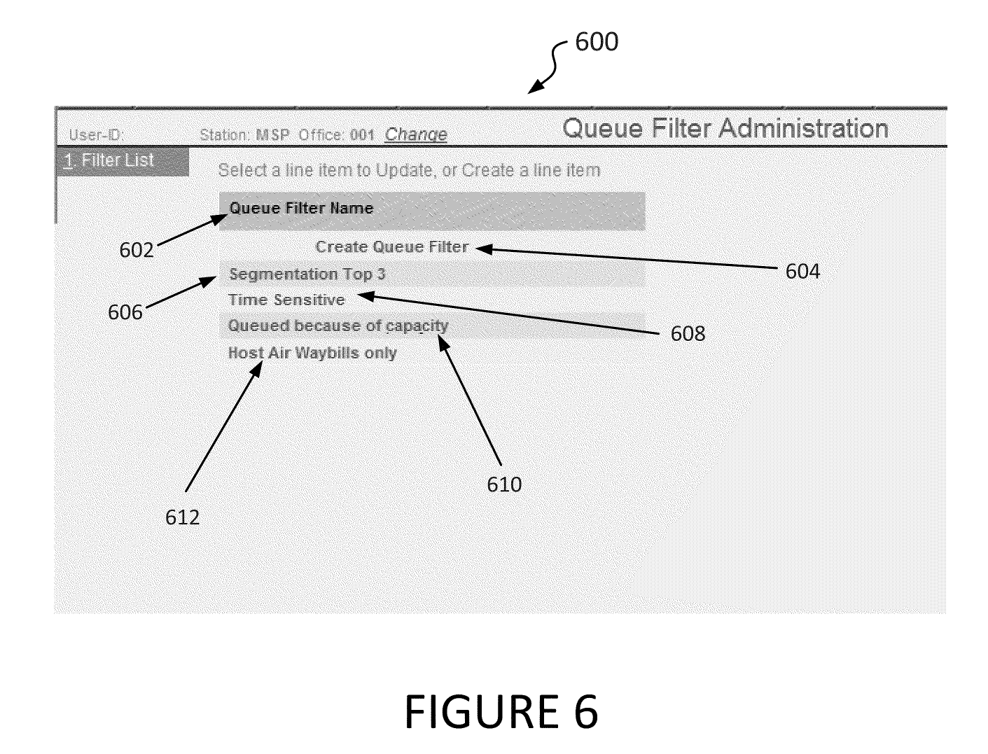

FIG. 6 is an illustration of an interface that a user may operate to create a filter for a booking or an air waybill according to one embodiment. This interface 600 may be entitled ‘Queue Filter Information’ and may include several buttons related to the creation of a queue filter. A call center 100 user with authorization, flight control center 120 user, or any user of the centralized system may click on the ‘Create Queue Filter’ button 604 to create a filter for viewing or working on desired bookings at the user's discretion. Any of the attributes 402-430 and 502-510 as well as the attributes in FIGS. 4 and 5 that are not discussed in this disclosure and attributes that may be obvious to a person of ordinary skill in the art at the time of the invention may be filtered by a system user and viewed on the user interface. The other functions that are operated on interface 600 may include one or more of a queue filter name 602, a customer segmentation priority list 606, a time sensitive list 608, a list of bookings that have been queued due to capacity 610, a list of host air waybills 612, and the like.

The customer segmentation priority list 606 may show bookings based on a segmentation field. The customer segmentation field may be a list of values, such as A-Z that identify the shipping participant that is responsible for the charges related to the shipment. A time sensitive list 608 may contain bookings that are automatically populated and filtered by time to inform users of bookings that need to be worked on by a specific date. In addition to fields 606-612, other pre-filtered attributes may be integrated into the user interface by a system developer or by a user as a user preference. In one embodiment, the number of filters that are created may be limited by a threshold or may be limitless.

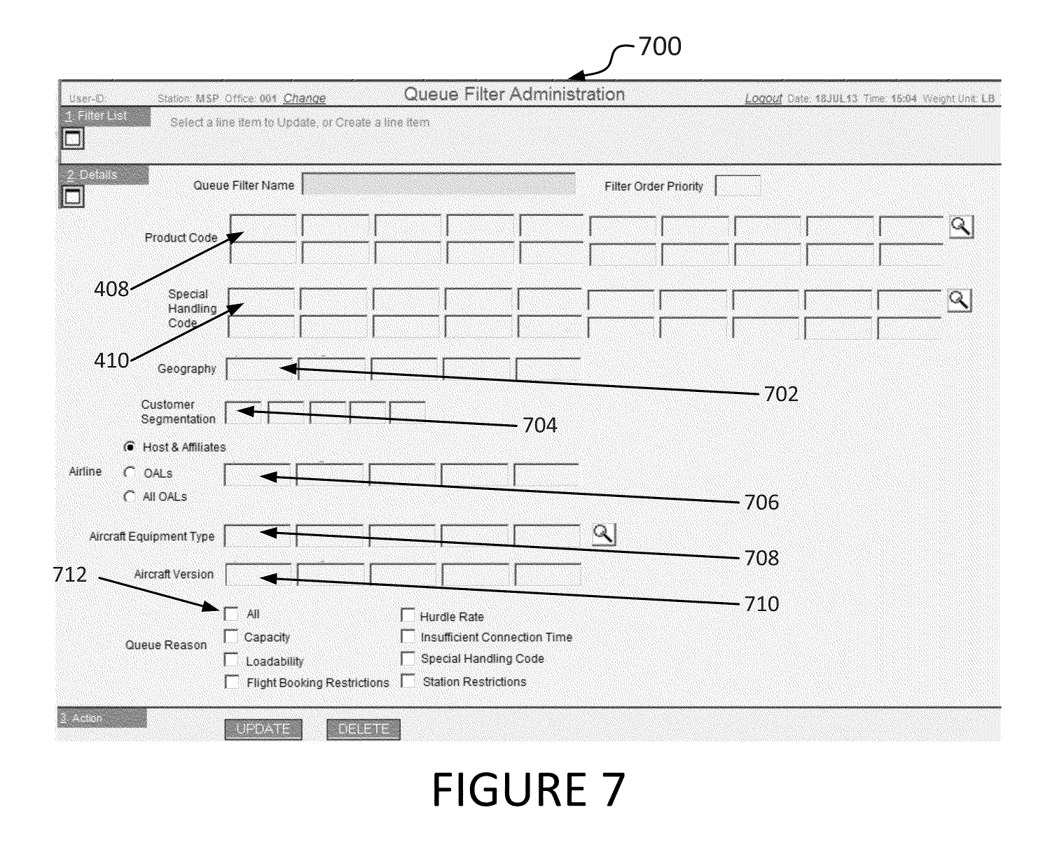

FIG. 7 is an illustration of an interface that is displayed when a user creates a queue filter according to one embodiment. This interface 700 may be entitled ‘Queue Filter Information’ and include several fields related to attributes of a booking or an air waybill. When the queue filter name 602 is selected, that field may be viewed on interface 700. Furthermore, several other attributes on interface 700 may include product codes 408, special handling codes 410, geographic regions 702, a customer segmentation 704, other airlines (OAL) fields 706, aircraft equipment types 708, aircraft versions 710, reasons why a bookings are queued 712, and the like.

In one embodiment, in the ‘Details’ section, a user may filter up to a threshold of 20 bookings by product codes 408. Similarly, a user may filter up to a threshold of 20 bookings by special handling codes 410, and five bookings each by geographic region 702, customer segmentation 704, OAL 706, aircraft equipment type 708, and aircraft version 710. These thresholds may be implemented into the interface to maintain an efficient use of processing unit 202 for searching the database 204 for bookings. The queue reason 712 may contain a collection of check boxes that for why a booking is queued, including ‘All,’ ‘Capacity,’ ‘Loadability,’ ‘Flight Booking Restrictions,’ ‘Hurdle Rate,’ ‘Insufficient Connection Time,’ ‘Special Handling Code,’ and ‘Station Restrictions.’

A user may modify the queue filter with additional information, such as adding more geographic regions 702 or queue reasons 712. Additionally, a user may erase information in the attribute fields that are no longer included in the queue filter. After the information has been added or erased in the interface 700, a user may click on the ‘Update’ button in the ‘Action’ section to process the changes to the queue filter. In one embodiment, a filter may be active for an infinite period of time after the filter is created. In another embodiment, a filter may be active for a finite amount of time set by a user or as a predefined condition of the system 200. A user may delete a filter if the filter is no longer applicable or desired by clicking on the ‘DELETE’ button.

Finally, a filter priority field 714 may be integrated into the interface 700. The filter priority may contain one field (as shown in the figure) or multiple fields (one for each attribute). In one embodiment, when two or more fields, such as product code field 408 and aircraft version 710, contain information, a user may enter a ‘1’ into the field associated with the product code 408 and a ‘2’ into the filter priority field associated with the aircraft version 710. A ‘1’ may signify that the filter should prioritize the filtering of bookings or air waybills by the product code before prioritizing the filtering of bookings or air waybills by the aircraft version. A person of ordinary skill in the art may appreciate several additional options of prioritizing filters.

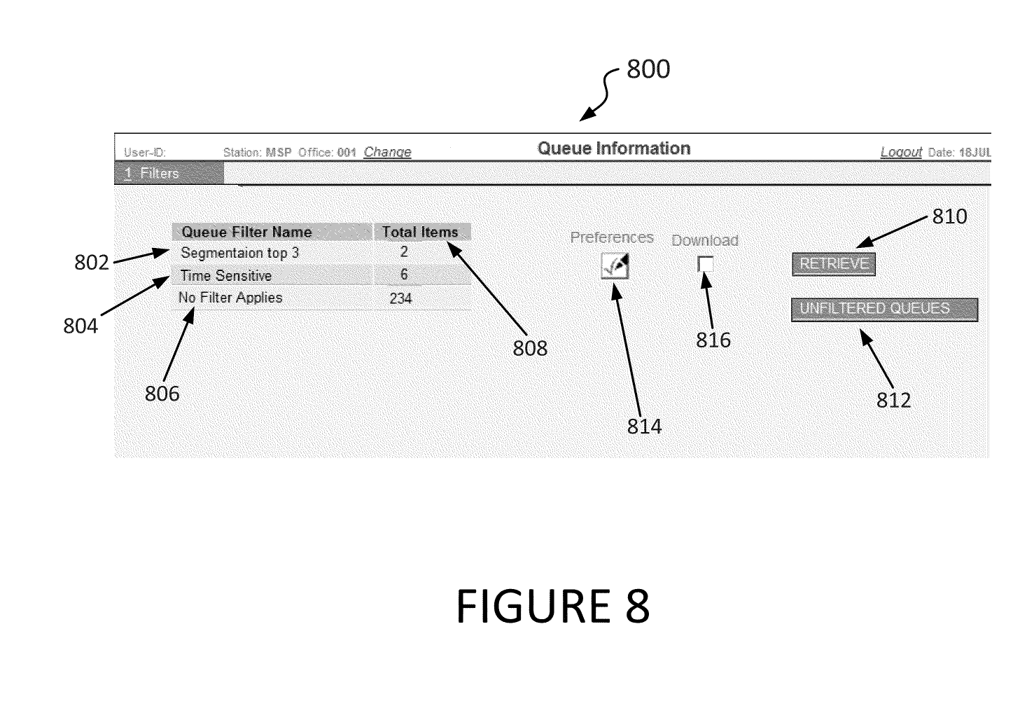

FIG. 8 is an illustration of an interface that is displayed when a user views a summary of active filters according to one embodiment. This interface 800 may be entitled ‘Queue Information’ and comprise of a collection of queue filters and their quantity. In one embodiment, a queue filter summary may comprise a table of queue filter names and the total quantity of items associated with the queue filter name. For example, the queue filter names may comprise ‘Segmentation top 3’ 802, ‘Time Sensitive’ 804, and ‘No Filter Applies’ 806, but any combination of predefined and user-defined queue filter names may be created and displayed on interface 800. The column entitled ‘Total Items’ 808 may denote the number of items that are associated with the queue filter name out of the total number of bookings and air waybills in the database 204. The ‘No Filter Applies’ 806 queue filter name may indicate the number of bookings and air waybills in the database 204 that are not a part of any filter.

In one embodiment, a user of this interface may click on the queue filter name to see information related to the bookings and air waybills in the queue filter. Upon clicking the queue filter name, a window may appear on the screen showing detailed information related to the filter. The window may contain a child window that opens inside a parent window or a separate window external to the ‘Queue information’ interface 800. In addition, a user may right-click on the queue filter name to display additional functions that may be invoked on the queue filter. In a different embodiment, a number of queue filter names may be highlighted for viewing at one time by clicking on the ‘RETRIEVE’ button 810. When a user clicks on one or more queue filter names, a distinct color may be applied to the queue filter name to signify that the queue filter name has been selected for viewing and modification. After the queue filter names are highlighted and the ‘RETRIEVE’ button 810 is clicked, the highlighted queue filters may be displayed in separate interface windows or within the same interface window. A person of ordinary skill in the art may appreciate the number of different ways that information may be displayed on an interface.

The interface 800 may include an ‘UNFILTERED QUEUES’ button 812, a ‘Preferences’ button 814, and a ‘Download’ check box 816. The ‘UNFILTERED QUEUES’ button 812 may output all of the unfiltered queued bookings and air waybills in the database 204. This button 812 may perform the same function as the ‘No Filter Applies’ button 806. If queue filter names are highlighted, the ‘UNFILTERED QUEUES’ button 812 may override the highlighted filters and display the unfiltered queues. The ‘Preferences’ button 814 may be clicked by a user to display any preference that may be predefined or user-defined on the interface 800. The ‘Download’ check box 816 may be checked prior to the ‘RETRIEVE’ 810 or ‘UNFILTERED QUEUES’ button 812 being clicked. After the check box is checked and either buttons 810 or 812 is clicked, an output may be generated in a file format, such as an spreadsheet, a document file, a text file, a table, a graphical representation, and the like.

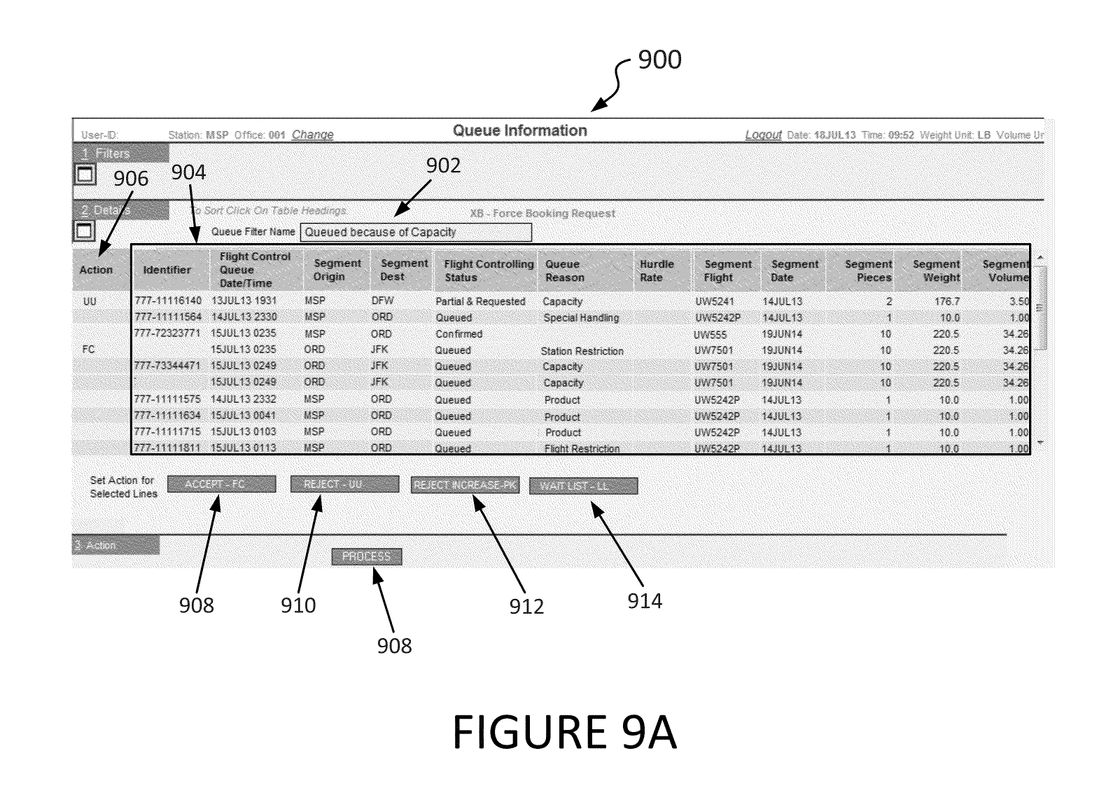

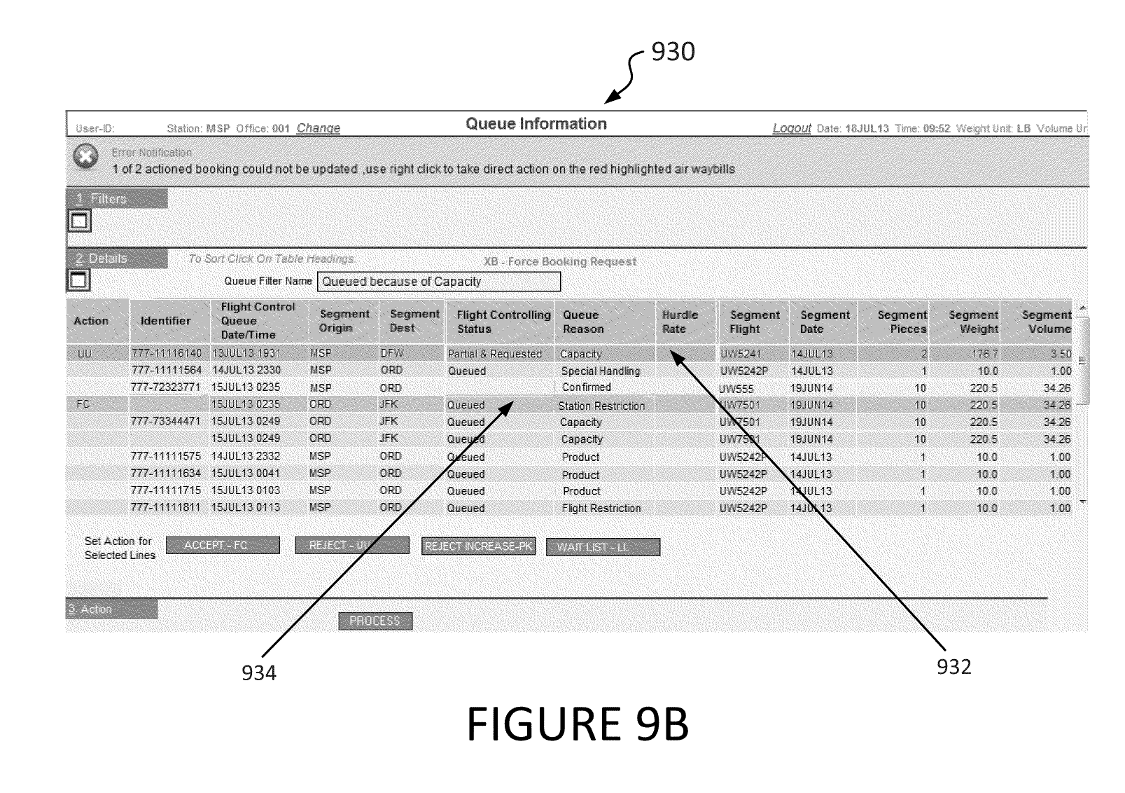

FIG. 9A is an illustration of an interface that is displayed when a user requests to view information related to a queue filter according to one embodiment. This interface 900 may also be entitled ‘Queue Information’ and comprise several categories related to a queue filter name. When a user clicks on a queue filter name, such as ‘Queued because of Capacity’ in interface 800, a list of bookings and air waybills 904 may be displayed under the filter title box 902 of interface 900. This list may include an identifier, a flight control queue date and time, a segment origin, a segment destination, a flight controlling status, a queue reason, a hurdle rate, a segment flight name, a segment date, a number of segment pieces, a segment weight, a segment volume, as well as any other attributes not listed in the figure. Some of the bookings and air waybills may be displayed without an identifier signifying that particular booking or air waybill may belong to the next booking or air waybill above in the list that has an identifier, thus shares the same identifier name.

An action column 906 may be displayed in interface 900 that symbolizes a desired action to be taken on the booking. In one embodiment, the action column 906 may be populated with actions represented by an ‘ACCEPT-FC’ button 908, a ‘REJECT-UU’ button 910, a ‘REJECT INCREASE-PK’ button 912, and a ‘WAITLIST-LL’ button 914. When a user clicks the ‘ACCEPT-FC’ button 908, the booking may be accepted, and a code ‘FC’ may be placed in column 906 next to the booking. When a user clicks the ‘REJECT-UU’ button 910, a booking may be rejected, and a code ‘UU’ may be placed in column 906 next to the booking. Moreover, when a user clicks the ‘REJECT INCREASE-PK’ button 912, the increase in the booking may be rejected, and a code ‘PK’ may be placed in column 906 next to the booking. This action may return the bookings to the original amounts before the increase was made. Furthermore, when a user clicks the ‘WAITLIST-LL’ button 914, the booking may be waitlisted, and a code ‘LL’ may be placed in column 906 next to the booking. It is understood that a person of ordinary skill in the art may appreciate other actions that could be taken on the bookings not listed in the figure.

After one or more actions have been populated in the list 904, a user may click a ‘PROCESS’ button 916 to communicate with the processing unit 202 to process the desired actions. A user may also right-click on a booking in list 904 to expose a drop-down menu of actions 908-914 or additional actions that may be taken on the bookings. In addition, a user may perform no action on any of the bookings. When this occurs, clicking the ‘process’ button 916 may process the same state of bookings in list 904 or return an error message informing the user that an action must be performed. In the latter case, a button entitled ‘No Action’ may be populated for every booking in which no action will be applied. In a preferred embodiment, actions may only be applied after the ‘PROCESS’ button 916 has been clicked.

FIG. 9B is an illustration of an interface that is displayed when an action is submitted to the system according to one embodiment. Interface 930 may comprise an updated version of interface 900 displaying messages to the user. When the ‘PROCESS’ button 916 is clicked in interface 900, the system 200 may attempt to process the desired actions. In one embodiment, a message may be displayed on the interface 900 related to processing the actions and inform the user that all of the actions have been confirmed. In another embodiment, some of the actions have been confirmed and others may be rejected by the system 200. A first color may be highlighted on the bookings that have been confirmed 932, and a second color may be highlighted on the bookings that have been rejected 934. A user may right-click on the rejected booking 934 to view a drop-down menu comprising actions that may be taken on the booking, explanations for the rejection, and the like. All of the action buttons 908-914 and the process button 916 in this updated interface may be clicked to perform a desired action or process a requested action.

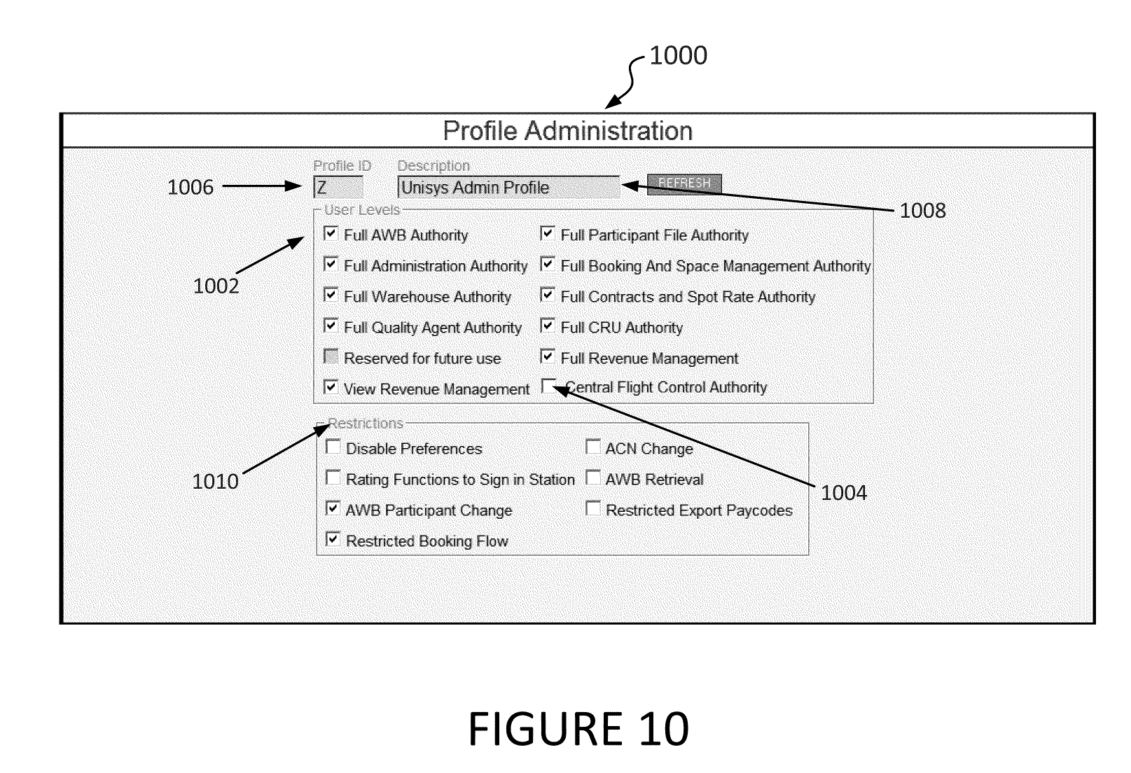

FIG. 10 is an illustration of an interface that is displayed to grant authority to a user according to one embodiment. This interface 1000 may also be entitled ‘Profile Information’ and comprise several levels of authority and restrictions that may be placed on a user's ability to reserve bookings and generate air waybills. Interface 1000 may be exposed to a system administrator of a central authority to allow or disallow access to specific functions related to receiving and managing bookings and air waybills. User levels 1002 may comprise a collection of check boxes including Full AWB Authority, Full Administration Authority, Full Warehouse Authority, Full Quality Agent Authority, View Revenue Management, Full Participant File Authority, Full Booking And Space Management Authority, Full Contracts and Spot Rate Authority, Full CRU Authority, Full Revenue Management, and the like. Specifically, the user levels 1002 may also comprise a new check box entitled ‘Central Flight Control Authority’ 1004, thus allowing a user to operate system 200 to reserve, generate, and manage bookings and air waybills regardless of location. This check box that may allow multiple bookings to be worked on simultaneously, hence alleviating any delays in handling bookings and resulting in an efficiently integrated system.

Interface 1000 may also comprise a profile identifier 1006 field and a description 1008 field. The profile identifier 1006 may be invoked to designate a class of a system user. The description 1008 may comprise a description of a type of user, a user's name, and the like. In addition, interface 1000 may contain a collection of check boxes that pertain to user restrictions 1010, such as Disable Preferences, Rating Functions to Sign in Station, AWB Participant Change, Restricted Booking Flow, ACN Change, AWB Retrieval, Restricted Export Paycodes, and the like. In one embodiment, restrictions 1010 may override user levels 1002. For example, if the Full AWB Authority check box (a user level check box) is checked, and this check box typically does not enable AWB Participant Change functionality, the AWB Participant Change check box (a restriction check box) may be checked and that restriction may be added to the Full AWB Authority user level. A person of ordinary skill in the art may appreciate that other buttons, fields, and or check boxes may be integrated into interface 1000 actions that could be taken on the bookings not listed in the figure.

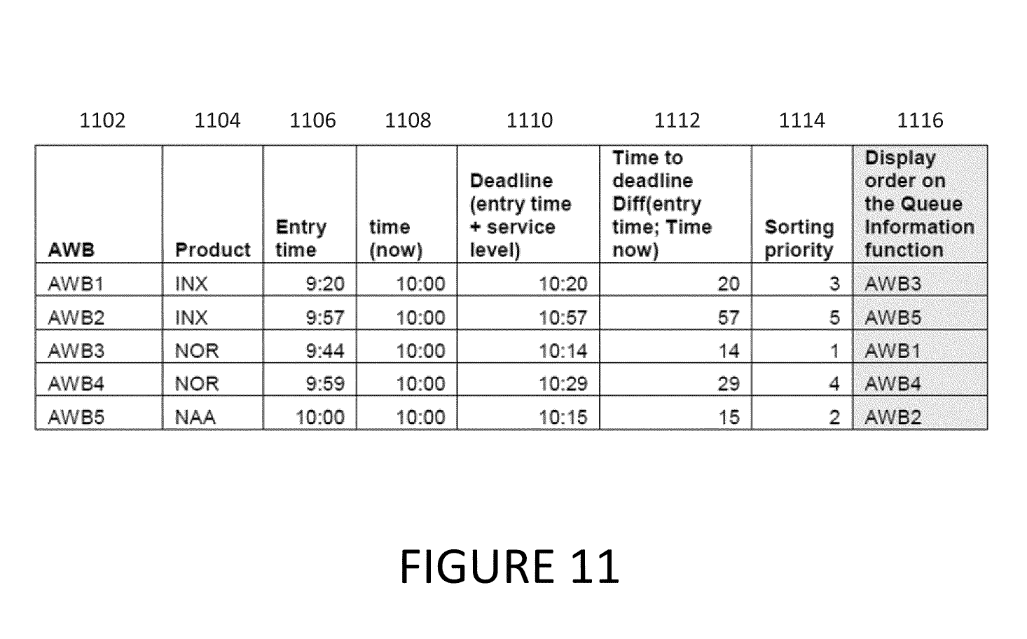

FIG. 11 is a table depicting an example of assigning priority for an air waybill according to one embodiment. The table 1100 may comprise of columns of attributes based on the following categories: AWB (air waybill) 1102, product code 1104, entry time 1106, current time 1108, deadline 1110, time to deadline 1112, sorting priority 1114, display order 1116, and the like. The AWB attribute 1102 may list a collection of air waybills by an AWB name or identifier, and the product code 1004 may be associated to each air waybill. Attributes 1106-1112 may be utilized to determine a sorting priority 1114. The sorting priority attribute 1114 may display a priority of handling air waybills based on AWB 1112. Lastly, the display order attribute 1116 may display the names of the air waybills in a prioritized order.

In one embodiment, an air waybill may be filtered by deadline 1110. The entry time 1106 may represent the time that the air waybill was entered into the system 200. The deadline 1110 may include the sum of the entry time 1106 and the service level (not shown) associated with the product code. The service level may represent the amount it takes to complete a task related to the product code 1104. In the embodiment of FIG. 11, the service level for product codes ‘INX,’ ‘NOR,’ and ‘NAA’ are 60, 30, and 15 minutes, respectively. For entry AWB2, since the entry time is 9:57 and the product code is ‘INX’, the deadline would be 10:57. The time to deadline attribute 1112 may comprise the difference between the deadline 1110 and the current time 1108. For entry AWB2, since the deadline is 10:57 and the current time is 10:00, the time to deadline would be 57 minutes. The sorting priority 1114 may display the order of priority for the air waybills based on the time to deadline attribute 1112. In this figure, ‘1’ may signify that a system user should work on AWB3 first. The display order attribute 1116 may display the new prioritized order of air waybills. Based on the information in this figure, AWB5 should be worked on after AWB3 followed by AWB1, AWB2, and AWB4. A person of ordinary skill in the art may appreciate that other attributes may be used in prioritizing an order of working on air waybills.

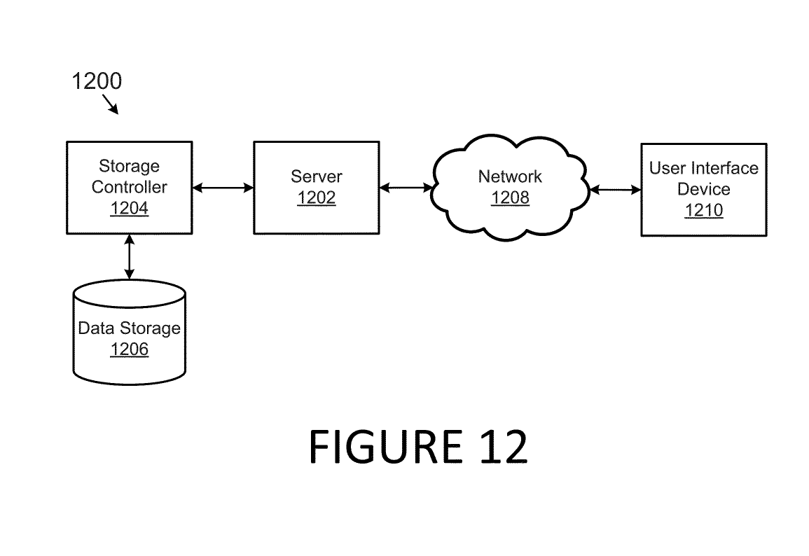

FIG. 12 illustrates one embodiment of a system for an information system, including a system for generating an application and invoking a method according to one embodiment. The system 1200 may include a server 1202, a data storage device 1206, a network 1208, and a user interface device 1210. In a further embodiment, the system 1200 may include a storage controller 1204, or storage server configured to manage data communications between the data storage device 1206 and the server 1202 or other components in communication with the network 1208. In an alternative embodiment, the storage controller 1204 may be coupled to the network 1208. The system 1200 may support code analysis by hosting the database 204 of FIG. 2 on the server 1202.

In one embodiment, the user interface device 1210 is referred to broadly and is intended to encompass a suitable processor-based device such as a desktop computer, a laptop computer, a personal digital assistant (PDA) or tablet computer, a smartphone, or other mobile communication device having access to the network 1208. In a further embodiment, the user interface device 1210 may access the Internet or other wide area or local area network to access a web application or web service hosted by the server 1202 and may provide a user interface for communicating with the notification manager 116, diagnostic manager 118, and remedy manager 120 of FIG. 1 if these components do not reside on the system 100.

The network 1208 may facilitate communications of data between the server 1202 and the user interface device 1210. The network 1208 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

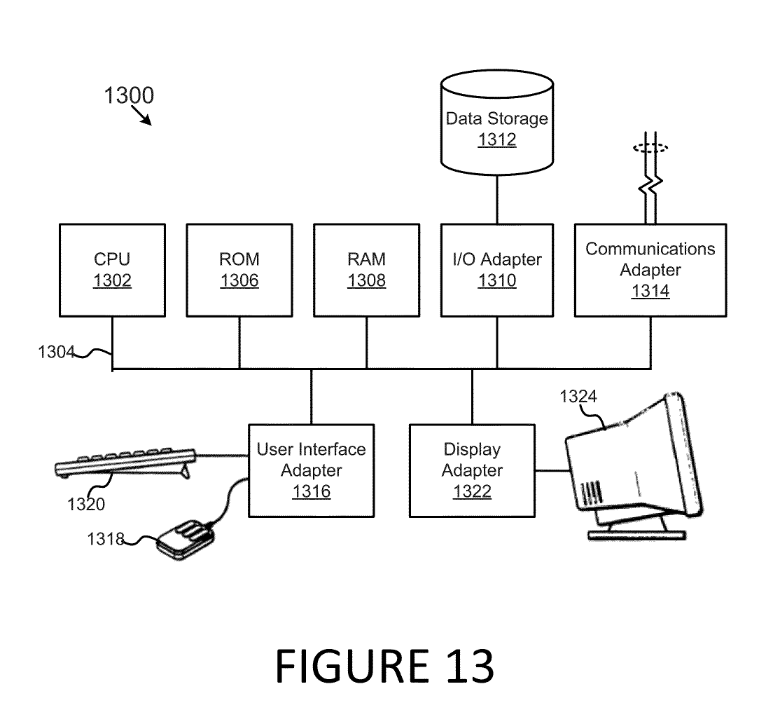

FIG. 13 illustrates a computer system adapted according to certain embodiments of the server and/or the user interface device. The central processing unit (“CPU”) 1302 is coupled to the system bus 1304. Although only a single CPU is shown, multiple CPUs may be present. The CPU 1302 may be a general purpose CPU or microprocessor, graphics processing unit (“GPU”), and/or microcontroller. The present embodiments are not restricted by the architecture of the CPU 1302 so long as the CPU 1302, whether directly or indirectly, supports the operations as described herein. The CPU 1302 may execute the various logical instructions according to the present embodiments.

The computer system 1300 may also include random access memory (RAM) 1308, which may be synchronous RAM (SRAM), dynamic RAM (DRAM), synchronous dynamic RAM (SDRAM), or the like. The computer system 1300 may utilize RAM 1308 to store the various data structures used by a software application. The computer system 1300 may also include read only memory (ROM) 1306 which may be PROM, EPROM, EEPROM, optical storage, or the like. The ROM may store configuration information for booting the computer system 1300. The RAM 1308 and the ROM 1306 hold user and system data, and both the RAM 1308 and the ROM 1306 may be randomly accessed.

The computer system 1300 may also include an input/output (I/O) adapter 1310, a communications adapter 1314, a user interface adapter 1316, and a display adapter 1322. The I/O adapter 1310 and/or the user interface adapter 1316 may, in certain embodiments, enable a user to interact with the computer system 1300. In a further embodiment, the display adapter 1322 may display a graphical user interface (GUI) associated with a software or web-based application on a display device 1324, such as a monitor or touch screen.

The I/O adapter 1310 may couple one or more storage devices 1312, such as one or more of a hard drive, a solid state storage device, a flash drive, a compact disc (CD) drive, a floppy disk drive, and a tape drive, to the computer system 1300. According to one embodiment, the data storage 1312 may be a separate server coupled to the computer system 1300 through a network connection to the I/O adapter 1310. The communications adapter 1314 may be adapted to couple the computer system 1300 to the network 1308, which may be one or more of a LAN, WAN, and/or the Internet. The user interface adapter 1316 couples user input devices, such as a keyboard 1320, a pointing device 1318, and/or a touch screen (not shown) to the computer system 1300. The keyboard 1320 may be an on-screen keyboard displayed on a touch panel. The display adapter 1322 may be driven by the CPU 1302 to control the display on the display device 1324. Any of the devices 1302-1322 may be physical and/or logical.

The applications of the present disclosure are not limited to the architecture of computer system 1300. Rather the computer system 1300 is provided as an example of one type of computing device that may be adapted to perform the functions of the server 1202 and/or the user interface device 1210. For example, any suitable processor-based device may be utilized. including, without limitation, personal data assistants (PDAs), tablet computers, smartphones, computer game consoles, and multi-processor servers. Moreover, the systems and methods of the present disclosure may be implemented on application specific integrated circuits (ASICs), very large scale integrated (VLSI) circuits, or other circuitry. In fact, persons of ordinary skill in the art may utilize any number of suitable structures capable of executing logical operations according to the described embodiments. For example, the computer system may be virtuatized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, by a computing system, at least one booking request from a call center, where the at least one booking request comprises one or more attributes related to the at least one booking request from the call center;
receiving, by the computing system, at least one booking request from a flight control center, where the at least one booking request comprises one or more attributes related to the at least one booking request from the flight control center;
filtering, by the computing system, the at least one booking request from the call center and the at least one booking request from the flight control center in response to a selection of at least one of the one or more attributes related to the at least one booking request from the call center and the one or more attributes related to the at least one booking request from the flight control center; and
generating, by the computing system, an output based on the filtering of the at least one booking request from the call center and the at least one booking request from the flight control center.

2. The method of claim 1, further comprising filtering, by the computing system, the at least one booking request from the call center and the at least one booking request from the flight control center based on a filter priority.

3. The method of claim 1, further comprising providing, by the computing system, a user an authoritative privilege to operate the computing system.

4. The method of claim 1, further comprising receiving, by the computing system, an action on a queued booking.

5. The method of claim 4, further comprising providing, by the computing system, a message to the user that the action on the queued booking is confirmed or rejected.

6. The method of claim 1, further comprising aggregating, by the computing system, the at least one booking request from the call center and the at least one booking request from the flight control center.

7. The method of claim 6, further comprising storing, by the computing system, the aggregated booking requests from the call center and the flight control center into a database.

8. An apparatus, comprising:
a processor; and
a memory coupled to the processor, wherein the processor is configured to perform the steps of:
receiving, by a computing system, at least one booking request from a call center, where the at least one booking request comprises one or more attributes related to the at least one booking request from the call center;
receiving, by the computing system, at least one booking request from a flight control center, where the at least one booking request comprises one or more attributes related to the at least one booking request from the flight control center;
filtering, by the computing system, the at least one booking request from the call center and the at least one booking request from the flight control center in response to a selection of at least one of the one or more attributes related to the at least one booking request from the call center and the one or more attributes related to the at least one booking request from the flight control center; and
generating, by the computing system, an output based on the filtering of the at least one booking request from the call center and the at least one booking request from the flight control center.

9. The apparatus of claim 8, in which the processor is further configured to perform the step of filtering, by the computing system, the at least one booking request from the call center and the at least one booking request from the flight control center based on a filter priority.

10. The apparatus of claim 8, in which the processor is further configured to perform the step of providing, by the computing system, a user an authoritative privilege to operate the computing system.

11. The apparatus of claim 8, in which the processor is further configured to perform the step of receiving, by the computing system, an action on a queued booking.

12. The apparatus of claim 11, in which the processor is further configured to perform the step of, providing, by the computing system, a message to the user that the action on the queued booking is confirmed or rejected.

13. The apparatus of claim 8, in which the processor is further configured to perform the step of aggregating, by the computing system, the at least one booking request from the call center and the at least one hooking request from the flight control center.

14. The apparatus of claim 13, in which the processor is further configured to perform the step of storing, by the computing system, the aggregated booking requests from the call center and the flight control center into a database.

15. A computer program product, comprising:
a non-transitory computer readable medium comprising instructions which, when executed by a processor of a computing system cause the processor to:
receive, by a computing system, at least one booking request from a call center, where the at least one booking request comprises one or more attributes related to the at least one booking request from the call center;
receive, by the computing system, at least one booking request from a flight control center, where the at least one booking request comprises one or more attributes related to the at least one booking request from the flight control center;
filter, by the computing system, the at least one booking request from the call center and the at least one booking request from the flight control center in response to a selection of at least one of the one or more attributes related to the at least one booking request from the call center and the one or more attributes related to the at least one booking request from the flight control center; and
generate, by the computing system, an output based on the filtering of the at least one booking request from the call center and the at least one booking request from the flight control center.

16. The computer program product of claim 15, in which the instructions further cause the processor to filter, by the computing system, the at least one booking request from the call center and the at least one booking request from the flight control center based on a filter priority.

17. The computer program product of claim 15, in which the instructions further cause the processor to receive, by the computing system, an action on a queued booking.

18. The computer program product of claim 17, in which the instructions further cause the processor to provide, by the computing system, a message to the user that the action on the queued booking is confirmed or rejected.

19. The computer program product of claim 15, in which the instructions further cause the processor to aggregate, by the computing system, the at least one booking request from the call center and the at least one booking request from the flight control center.

20. The computer program product of claim 19, in which the instructions further cause the processor to store, by the computing system, the aggregated booking requests from the call center and the flight control center into a database.
